(19) United States
(12) Patent Application Publication
(10) Pub. No.: US 2016/0002957 A1
(43) Pub. Date: Jan. 7, 2016

(54) FILE CABINET DRAWER LOCKING DEVICE

(71) Applicants: Albert Long Trinh, Maineville, OH (US); Dennis Sam TRINH, Maineville, OH (US); Toan TRINH, Maineville, OH (US)

(72) Inventors: Albert Long Trinh, Maineville, OH (US); Dennis Sam TRINH, Maineville, OH (US); Toan TRINH, Maineville, OH (US)

(21) Appl. No.: 14/854,938

(22) Filed: Sep. 15, 2015

Related U.S. Application Data
(63) Continuation-in-part of application No. PCT/US2014/027648, filed on Mar. 14, 2014.
Application No. PCT/US2014/027648 is a continuation-in-part of application No. 13/843,847, filed on Mar. 15, 2013.
Application No. 13/843,847 is a continuation-in-part of application No. 14/032,712, filed on Sep. 20, 2013.

(51) Int. Cl. E05B 65/46; E05B 63/00; E05B 65/52

(52) U.S. Cl. CPC E05B 65/467; E05B 65/46; E05B 65/52; E05B 63/0052

(57) ABSTRACT

A locking system for the file drawers of a standard file cabinet, and in particular a steel-constructed file cabinet. The system includes a locking device and a locking means, the locking device having an elongated bar that includes a locking end and an opposing attaching end. The attaching end can include a laterally-extending upturned wall at its forward end that hooks or clasps to an interior wall along the upper edge of the file drawer frame. The locking means is a ratcheting lock that releasably and ratchetingly engage teeth along an edge of the elongated bar. The attaching end can be adhesively or magnetically held in place as the locking end is extended through a slot opening between the file drawer and the drawer opening frame as the file drawer is closed, and the ratcheting lock secures the locking device and the closed drawer from opening.

### CROSS-REFERENCE TO RELATED APPLICATIONS

This application is a continuation-in-part application of PCT International Application PCT/US2014/027648, filed Mar. 14, 2014 (pending), which was a continuation-in-part of U.S. application Ser. No. 13/843,847, filed on Mar. 15, 2013, and a continuation-in-part of U.S. application Ser. No. 14/032,712, filed on Sep. 20, 2013, the disclosures of which are incorporated herein by reference in their entireties.

### FIELD OF THE INVENTION

The present invention relates generally to a locking device for drawers of a file cabinet.

### BACKGROUND OF THE INVENTION

Lower-priced file cabinets are commonly sold without a built-in lock. Some other cabinets may originally have a built-in lock, but the keys may be malfunctioning or the key may be lost. In these cases, a replacement lock provided by a locksmith may be expensive. It is desirable to have an inexpensive non-built-in locking device to lock a drawer of the file cabinet, in order to store and secure valuable, sensitive or confidential documents.

A first type or style of file cabinet includes a main drawer disposed within a main drawer frame, the upper structure of main drawer frame defining a drawer opening including a vertical outer wall having a lower edge and a lower horizontal wall of a wall thickness extending perpendicularly from the lower edge into the drawer opening.

A second type or style of file cabinet includes a main drawer disposed within a main drawer frame, the upper structure of main drawer frame defining a drawer opening including a vertical outer wall having a lower edge, a lower horizontal wall of a wall thickness extending perpendicularly from the lower edge into the drawer opening, and an interior vertical wall extending perpendicularly from an inner edge of the lower horizontal wall.

### SUMMARY OF THE INVENTION

The present invention provides a locking system for standard file drawer cabinets, and in particular steel-constructed filing cabinets. The locking system includes a locking device and a locking means. The locking device includes a main elongated body that includes a locking end and an opposing attaching end. A distal end of the attaching end includes a laterally-extending member, extending traverse to the main elongated body, to engage a portion of the drawer-opening frame of the file cabinet. The locking end is configured to extend forwardly through a slot opening between the drawer-opening frame and a top edge of the drawer. The locking means is securable and lockable to the locking end.

In an aspect of the invention, the distal end of the attaching end includes a laterally-extending, upturned portion, and the laterally-extending member extends from the upturned portion. The upturned portion can include an upturned wall.

In another aspect of the invention, the laterally-extending member can be a hooking member or wall extending forwardly, from an upper end of the upturned wall toward the locking end, substantially parallel to the main elongated body and spaced apart from the main elongated body by an attaching gap having a dimension. The attaching gap accommodates insertion of a thickness of an inwardly- and transversely-extending horizontal wall of an upper edge of the drawer-opening frame (in certain file cabinet types), which defines a portion of the file drawer opening. The attaching gap is less in distance than the thickness of the transversely-extending horizontal wall of the drawer-opening frame, such that the hooking member and the main elongated body frictionally engage and grasp the horizontal wall of the drawer-opening frame. The hooking member is made of a resilient material, and is biased away from the main elongated body when the horizontal wall of the frame is inserted therebetween, The resilience of the hooking member exerts a normal force upon the inserted horizontal wall, which generates a frictional resistant force by the hooking member and the main elongated body upon the horizontal wall against its withdrawal from the attaching gap. The hooking member has sufficient resilience and a sufficient lateral length, to retain the locking device grasping to the horizontal wall of the frame while installing the locking means over the distal end of the locking end of the device.

In another aspect of the invention, the upturned wall is a laterally-extending upturned wall. A lower member or wall can extend from a lower end of the upturned wall. A distal end of the lower laterally-extending member and a distal end of the laterally-extending hooking member can have a substantially constant lateral attaching gap therebetween that accommodates insertion of the thickness of the horizontal wall of the drawer-opening frame. The gap between the lower laterally-extending member and the laterally-extending hooking member can be tapered toward the respective distal ends to form a pinching gap therebetween that accommodates frictional insertion of the thickness of the horizontal wall of the drawer-opening frame. The distal end of the upper laterally-extending hooking member further includes an upturned distal edge for easier insertion of the horizontal wall of the drawer-opening frame into the pinching gap.

In a further aspect of the invention, the upturned portion can include at least one upturned wall extending perpendicularly from and laterally outward from both sides of the main elongated body. A downturned member or wall can also be included, extending perpendicularly from the attaching end.

The attaching end can include a transverse base portion extending laterally with, and parallel to, the plane of the main elongated body, including from both side edges of the attaching end, wherein the upturned wall extends from the transverse base portion.

In another aspect of the invention, an upturned wall of the locking device can have a forward-facing surface that faces the locking end, and a fastener can be attached to the forward-facing surface of the upturned wall to attachment thereof to an interior vertical wall along an upper edge of a file drawer frame.

In another aspect of the invention, the laterally-extending upturned wall is a planar wall oriented substantially transverse and normal to the main elongated body, with the attaching end of the main elongated body attaching proximate the center of the planar wall. A fastener can be attached to the forward-facing surface of the planar wall for attachment to an interior vertical wall of the file drawer frame. Examples of a fastener can include a pressure-sensitive adhesive layer, a hook and loop mechanical fastener, and a magnetic fastener.

In a further aspect of the invention, the attaching end can further include a hinge. The laterally-extending member can include a laterally-extending clasping member extending from the hinge, the clasping member including an extending member or wall having a distal end, and a return member or wall extending from the distal end toward the hinge, and spaced apart from the extending member by a gap. The gap accommodates insertion of the return member over an upper edge of an interior vertical wall along an upper edge of a file drawer frame of a file cabinet.

In an aspect of the invention, laterally-extending members of the attaching end are laterally wider than, and typically twice, there times, four times, or more, wider than the width of the main elongated body, to provide a stable engagement with the interior vertical wall.

In an aspect of the invention, the locking end includes a plurality of teeth along a side edge of the elongated bar, and the locking means comprises a ratcheting lock to engage ratchetingly the teeth to secure the ratcheting lock to the locking end. The distal end of the locking end can be configured to extend less than about 3 inches (7.5 cm) from the distal end of the attaching end.

A first embodiment of a locking device includes a main elongated member that includes a locking end portion and an opposing attaching end portion, the attaching end portion including an upturned wall at the distal end of the attaching end, and a laterally-extending hooking member extending forward from an upper end of the upturned wall toward the locking end portion, substantially parallel to the main elongated member. The hooking member is spaced apart from the main elongated member at the attaching end by an attaching gap having a dimension, wherein the attaching gap accommodates insertion frictionally of the thickness of an inwardly-extending lower horizontal wall of a filing cabinet that defines the upper edge of the file drawer opening. The material of the hooking member is sufficiently resilient to be biased away from the main elongated body by the force applied onto the device when inserting the horizontal wall of the frame through the attached gap. The first locking device is useful in locking the drawer, especially the top drawer, of a first style of a file cabinet.

The attaching end can include a laterally-extending upturned wall and an upper and lower laterally-extending members extending from a lower end and the upper end of the upturned wall, respectively, toward the locking end. The lower laterally-extending member can include a transverse base extending from both opposing side edges of the main elongated body. The upper and lower laterally-extending members have a substantially constant attaching gap therebetween that accommodates insertion of the thickness of the lateral lower horizontal wall of the drawer opening with the locking end of the main elongated body extending forwardly and outward from the drawer opening. The attaching gap between the pair of laterally-extending members can taper towards the locking end, to a minimum attaching gap. The upper laterally-extending member can have an upturned distal edge for easier insertion of the lateral lower horizontal wall of the drawer opening. The locking means holds the attaching end of the locking device in engagement with the transversely-extending lower horizontal wall and prevents the locking device from being pulled through an upper slot formed when the file drawer is closed within the file drawer opening defined by the drawer frame, and prevents the file drawer from being pulled open.

A second embodiment of a locking device, the main elongated body includes an elongated bar that includes a locking end and an opposing attaching end, and means for engaging a portion of file drawer frame, fixed to the attaching end. The locking system of this embodiment is used with a file cabinet having a file drawer frame, wherein an upper portion of a file drawer frame includes an interior vertical wall that is engaged by the engaging means of the locking device. A locking means is then applied and secured to the locking end of the locking device that extends forward through an upper slot between the file drawer and the file drawer frame.

In a further aspect of the second embodiment of the locking device, the engaging means includes one or more upturned wall that extends perpendicularly and upward from, and normal to, the attaching end of the main elongated body. A second one or more downturned wall can extends perpendicularly and downward from, and normal to, the attaching end of the main elongated body. The upturned wall, or the upturned and downturned walls, has a laterally-extending dimension that is at least as wide as, and typically wider than, the width of the elongated bar, to provide a stable engagement with the interior vertical wall. The upturned wall has a height that covers at least a portion of the height of an interior vertical wall of the drawer frame, and can extend to or beyond the upper edge of the interior vertical wall of the file drawer frame.

In another aspect of the second embodiment of the locking device, the upturned wall of the locking device has a forward-facing surface that faces the locking end. A fastener can be provided that is fixed or attached to the forward-facing surface of the upturned wall, and has a fastening portion for releasable fastening to the interior vertical wall of the file drawer frame. The fastening portion of the fastener is selected from the group consisting of a pressure-sensitive adhesive layer, one of a hook and loop mechanical fastener (the other of the hook and loop mechanical fastener is affixed to the lateral vertical wall of the drawer frame), and a magnetic fastener.

The locking device can optionally include a downturned wall extending perpendicularly from the attaching end and substantially parallel with the upturned wall, to prevent manipulating of the locking device through an upper slot opening between the drawer and the drawer opening frame after the drawer has been closed and the locking means has been applied and secured to the locking device.

A third embodiment of a locking device of the invention includes a perpendicular, planarwall fixed to the attaching end of the elongated bar, proximate the transverse center and slightly below the vertical center of the planar wall. A fastener, as described in the second embodiment, can be fixed to the inner surface of the wall, just above the attaching end.

A fourth embodiment of a locking device of the invention includes an engaging means that includes a hinge extending rearwardly from the attaching end of the main elongated body, and a clasping member extending from the hinge. The clasping member includes an extending member or wall having a proximal end fixed to the hinge, and a distal end, and a return member or wall extending from the distal end of the extending member, and extending back toward the hinge. The return member is spaced apart from the extending member by a gap having a dimension, wherein the gap accommodates the thickness of the vertically extending interior wall of a file cabinet when the return member is hooked over the top edge of the interior vertical wall. The clasping member can be laterally co-extensive with (or, as wide as) the main elongated body, or more preferably can extend laterally beyond the side edges of, and transversely to, the main elongated body.

A fifth embodiment of a locking device of the invention includes an engaging means that includes a clasping member fixed to and extending perpendicularly from, and normal to, the attaching end. The clasping member includes an extending member or wall having a proximal end fixed to the attaching end, and a distal end, and a return member or wall extending from the distal end of the extending member and extending back toward the attaching end. The return member is spaced apart from the extending member by a gap having a dimension, wherein the gap accommodates the thickness of the vertically extending interior wall of a file cabinet when the return member is hooked over the top edge of the interior vertical wall. The clasping member can be laterally co-extensive with the main elongated body, or can extend laterally beyond the side edges of the main elongated body.

In the various embodiments of the invention, the locking end of a locking device herein can include a plurality of teeth along a side edge of the main elongated body. The teeth can include ratcheting teeth. The locking means can comprise a lock that includes a pawl having complementary teeth that engage and disengage with the teeth of the locking end, to secure and release the lock from the locking end, respectively. The pawl can include a ratcheting pawl with teeth that engage ratchetingly the row of teeth along an edge of the main elongated body to secure ratchetingly the locking means to the locking end of the locking device. A key-operated ratcheting lock that engages with the row of teeth or serrations along the main elongated body is well known to a person skilled in the art. Non-limiting examples of a ratcheting lock is described in U.S. Pat. Nos. 2,878,663 and 4,617,810, the disclosures of which are incorporated by reference in their entireties.

In an aspect of the invention, the attaching end can include a transverse base extending laterally with, and parallel to, the plane of the main elongated body, wherein the upturned wall or the hinge extends from a rearward edge of the transverse base. The transverse base can extend from either side edge, or preferably both side edges, of the attaching end.

The invention also relates to a method for securing closed a drawer within a drawer opening of a first style of file cabinet, comprising the steps of: a) opening a drawer of the file cabinet; b) attaching the attaching end portion of the first embodiment of the locking device to the lower horizontal wall of the upper portion of the file drawer frame; c) extending forward the locking end of the locking device through the drawer opening while closing the drawer to expose the locking end; and d) attaching a locking means to the locking end to prevent the drawer from opening within the drawer opening.

The present invention also provides a method for securing closed a file drawer within a drawer opening of a second style of file cabinet, comprising the steps of: a) opening a file drawer of a file cabinet disposed within drawer opening defined by a file drawer frame; b) attaching releasably the attaching end of a second embodiment, third embodiment, fourth embodiment, or fifth embodiment of the locking device, to a vertically extending interior wall of an upper portion of the file drawer frame; c) extending forward the locking end of the locking device through the drawer opening while closing the drawer, to expose the locking end through an upper slot opening between the file drawer and the file drawer frame; and d) attaching a locking means to the locking end to prevent the file drawer from opening within the drawer opening.

The invention also relates to instructions associated with the use of the locking device with a file cabinet, directing the consumer to attach the locking device to the file cabinet, and for closing and locking the drawer in the file cabinet. The invention also relates to a method of closing and locking and securing a drawer of a file cabinet using the locking device.

The present invention also provides an article of manufacture comprising: a) a locking device and optionally a lock and one or more keys; b) instructions for use by a consumer of the locking device with a file cabinet, for locking and securing a drawer of the file cabinet using the locking device; and c) a package for securing together the locking device, the optional lock and one or more keys, and the instructions. The instructions can direct the consumer to attach the locking device to the file cabinet, and for closing and locking the drawer in the file cabinet.

### BRIEF DESCRIPTION OF THE FIGURES

FIG. 1 shows a first embodiment of a locking device of the invention.

FIG. 2 shows a side elevation view of the locking device of FIG. 1.

FIG. 3 shows a perspective view of the locking device being inserted through the drawer opening of a filing cabinet.

FIG. 4 shows a side view of the FIG. 3.

FIG. 5A shows the locking device attached to a wall of the drawer opening of a first style of filing cabinet, with the file drawer closed and a locking means attached to the locking device to secure the drawer in the closed position.

FIG. 5B shows a plan view of the attached and secured locking device, from line 5B-5B of FIG. 5A.

FIG. 6 shows a second embodiment of a locking device of the invention.

FIG. 7 shows a side elevation view of the locking device of FIG. 6 to be installed into a file cabinet of the second style, with the drawer in the open position.

FIG. 8 shows the locking device of FIG. 7 installed into the file cabinet with the drawer in the closed position.

FIG. 9 shows a side elevation view of the locking device of FIG. 8 with a ratcheting lock installed

FIG. 10 shows a top plan view of the locking device of FIG. 9, viewed along line 10-10.

FIG. 11 shows a third embodiment of a locking device of the invention, with a guard.

FIG. 12 shows the locking device of FIG. 11 installed in a file cabinet, with the ratcheting lock installed, using a guard.

FIG. 13 shows a second embodiment of a locking device, using an alternative two-member fastener to attach the locking device to the file cabinet, with a guard.

FIG. 14 shows a fourth embodiment of a locking device of the invention that includes a hinge and a hooking member.

FIG. 15 shows the fourth embodiment of the locking device of FIG. 14 with the hinge pivoted to an installed position.

FIG. 16 shows a top plan view of the locking device of FIG. 14.

FIG. 17 shows a side elevation view of the locking device of FIG. 14 in the installed position attached to the file cabinet with the drawer in the open position.

FIG. 18 shows the locking device of FIG. 14 installed into the file cabinet with the drawer in the closed position with the ratcheting lock installed.

FIG. 19 shows a fifth embodiment of a locking device of the invention that includes a hooking member.

FIG. 20 shows the locking device of FIG. 19 installed into the file cabinet with the drawer in the closed position with the ratcheting lock installed.

FIG. 21 shows an article of manufacture including the locking device, a ratcheting lock, fastener elements, and instructions for use.

### DETAILED DESCRIPTION OF THE INVENTION

As used herein, the term “forward” refers to the front face of a file cabinet, and to an axial direction toward the front face of the file cabinet, as illustrated by arrow “F” in FIG. 3, while the term “rearward” refers to the rear of the file cabinet, and to an axial direction toward the rear of the file cabinet, as illustrated by arrow “R” in FIG. 3.

As used herein, the term “vertical” or “vertically”, refers to a direction between the top surface and the bottom of a standard file cabinet, while the term “horizontal” or “horizontally” refers to a direction generally parallel with a floor or other surface on which a standard file cabinet in placed, as illustrated by arrow “V” in FIG. 3.

As used herein, “laterally” means from side-to-side or outward from a side, in a direction perpendicular to the vertical and the axial directions of an element, such as the main elongated body or planar bar of the locking device.

As used herein, “transverse” or “transversely” means a direction orthogonal to “forward” and “vertical”, and is from side-to-side when facing rearwardly, as illustrated by arrow “T” in FIG. 3.

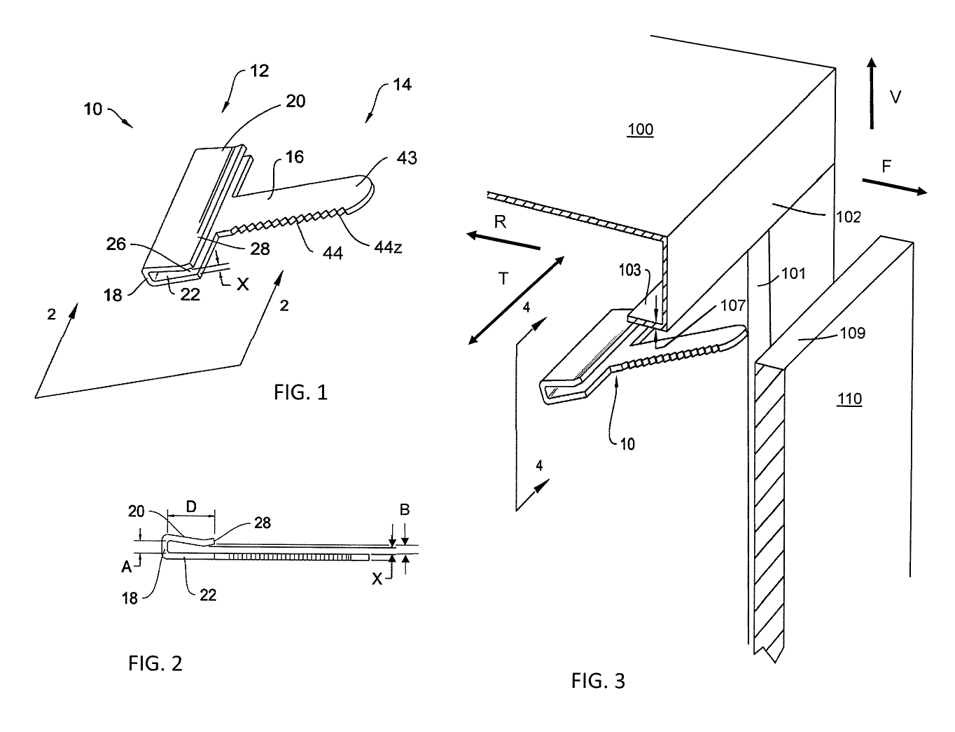

FIG. 1 shows a first embodiment of a locking device 10 having an attaching end 12 and a locking end 14. A main elongated body, illustrated as a planar bar 16, joins, and provides a portion of, the locking end 14 and the attaching end 12. An upturned wall 18 at the distal end of the attaching end 12 connects to a laterally-extending hooking member 20 that extends from an upper end of the upturned wall 18 toward the locking end 14. The hooking member 20 is substantially planar and substantially parallel to the planar bar 16 of the extending member. The minimum spacing of the gap separating the hooking member 20 from the planar bar 16 has a dimension X that accommodates insertion manually of the thickness 107 of an inwardly-extending horizontal wall 103, shown in FIG. 3, of an upper portion of the file drawer frame of the filing cabinet that defines the file drawer opening.

The locking end 14 comprises a rounded distal end 43 and a plurality of lock engaging elements 44 (teeth or ridges) disposed along the side edge of the planar bar 16. This locking end 14 is used to lock the drawer closed in the file drawer frame using a ratcheting lock 70 (shown in FIG. 5A with a partial cutaway to show the teeth 44) having a body with a transverse slot 72 which is of a size suitable to slidably receive the locking end 14. The lock 70 includes a pawl with teeth (not shown) that engage and disengage with the row of teeth 44, to selectively secure closed the drawer.

The illustrated locking device is useful in locking the drawer of a first style of a filing cabinet shown in FIGS. 3 through 5B that includes a main drawer 110 disposed within a main drawer frame 101, the upper structure of main drawer frame defining a drawer opening 104 including a vertical outer wall 102 having a lower edge and a lower horizontal wall 103 of a wall thickness 107 extending perpendicularly from the lower edge into the drawer opening.

The upturned wall 18 is also illustrated as being laterally-extending from the side edges of the main elongated body, or planar bar 16, and connects the upper laterally-extending or hooking member 20 with a lower laterally-extending member or transverse base 22. The upper and lower laterally-extending members or walls 20 and 22 can be laterally co-extensive, and have a substantially constant gap therebetween that accommodates insertion of the thickness 107 of the transversely-extending lower horizontal wall 103 of the drawer opening. The forward edges of the upper and lower walls 20 and 22 can extend forward from the upturned wall 18 about the same distance, or one can extend forward less than the other.

The locking end 14 of the planar bar 16 of the elongated locking portion 14 extends outward from the drawer opening. The gap between the pair of laterally-extending members of the attaching end 12 can have a tapering portion 26 toward the locking end, to form a pinching gap of minimum dimension X, sized to touch and frictionally engage the thickness 107 of the horizontal wall 103 of the file drawer frame. In this aspect, the forward edge of the upper wall 20 extends forward about the same distance or more forward than the forward edge of the lower wall 22, to maintain the pinching gap. The upper laterally-extending wall 20 can have an upturned distal edge 28 for easier insertion of the transversely-extending lower horizontal wall 103 of the file drawer frame.

It has been determined that the thickness 107 of the horizontal wall of the frame of a conventional metal file cabinet is about 0.8 mm or more, and up to about 1.1 mm, including 0.9 mm and 1.0 mm.

FIG. 2 shows a side elevation view of the locking device of FIG. 1 and defines the working dimensions of the attaching end 12. The gap A, defining the space at the upturned wall 18 between the upper wall 20 and the lower wall 22, is typically from 0.8 to about 1.5 mm, including from 0.9 to about 1.4 mm, and preferably about 1.2 mm, to accommodate the thickness of the horizontal wall 103 of the frame. The gap B, defining the height at the outer tip 28 of the upper wall 20, should be wide enough to insert the thickness of the transversely-extending lower horizontal wall 103 beneath the upper wall 20, with typically B being from about 1.0 mm to about 1.5 mm, including from about 1.1 mm to about 1.4 mm. The minimum narrow gap X is smaller than gap B, and defines the minimum gap between the surfaces of the upper wall 20 and the lower wall 22 that frictionally engage the horizontal wall 103 of the frame. The thickness of the minimum gap X, relative to the thickness 107 of the horizontal wall 103 of the frame, is inversely related to, and is expected to be inversely proportional to, the grasping frictional force, which prevents the locking device from detaching from the horizontal wall 103 when installing the ratcheting lock 70 onto the distal edge 43 of the locking portion 14. At a minimum, the minimum gap X is less than the thickness 107 of the horizontal wall 103. Preferably the minimum gap X is less than about 0.7 mm, and more preferably less than about 0.6 mm, and can be 0 mm with the upper wall 20 and the lower wall 22 in unbiased contact, or more.

The configuration of the locking device should also provide a minimum gap X that is not so small, or be constructed with a material resilience that is so large, that the grasping frictional force of the attaching end portion the locking device upon the horizontal wall is above a threshold that the locking device is either difficult to attach onto, or difficult to remove, from the horizontal wall 103. Typically, the grasping frictional force of the locking device upon the horizontal wall should be less that about 50 newtons (N), more preferably about 30 N.

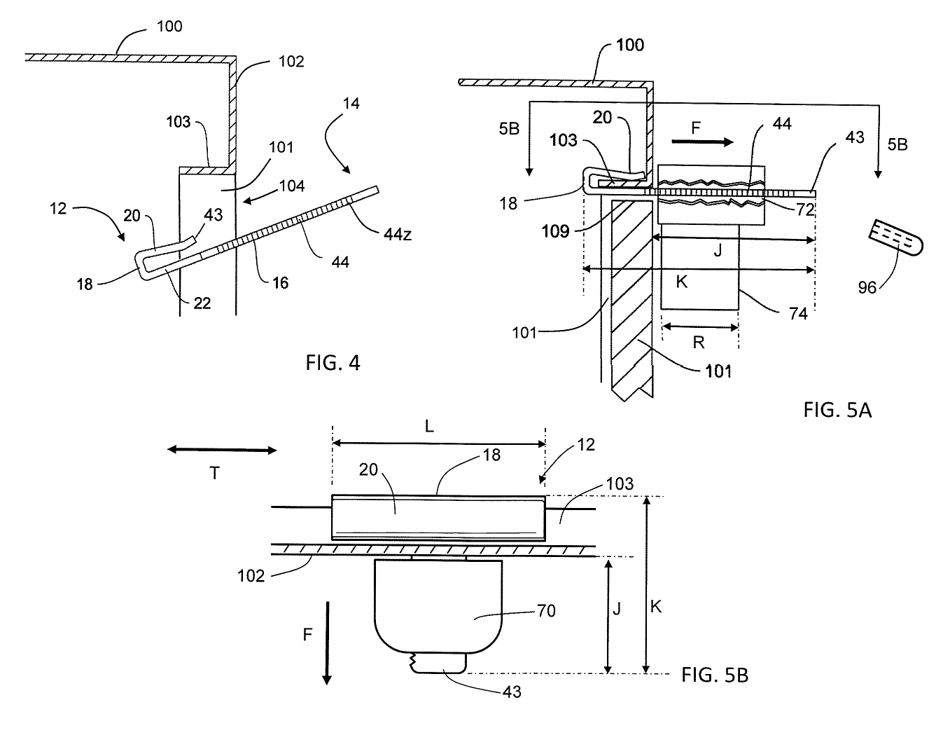

As shown in FIGS. 4, 5A and 5B, once the locking device is installed by hooking the attaching end 12 over the horizontal wall 103 of the drawer, the file drawer 110 is closed and a lock means, illustrated as a ratcheting lock 70 (and its teeth-engaging features), is installed over the rounded distal end 43 of the locking end 12 to engage ratchetingly to the plurality of teeth 44 along the side edge of the body 16, thereby securing closed the drawer 110. As the distal end 43 of the locking end 14 is inserted through the slot 72 of the ratcheting lock 70 during installation of the locking means, an installing force is required to move the ratcheting mechanism of the ratcheting lock 70 over and past each tooth 44, starting with the end-most tooth 44z. It has been determined that an installing force needed to move the ratcheting lock 70 along and over the plurality of teeth 44, to secure and lock the device, is at least 2 newtons (N), and preferably at least 3 N, and typically not more than about 5 N. During installation of the ratcheting lock 70, it may be preferred or necessary for the person to not grasp and hold by hand the locking device 10. For example, the distal portion of the locking end 14 that extends forward through the opening may be only long enough to install the ratcheting lock 70. In this situation, the frictionally engagement of the attaching end 12 (or grasping frictional force) of the locking device to the horizontal wall 103 should be of a force at least equal to, and more preferably significantly greater than, the installing force. In a preferred embodiment, the attaching end portion 12 grasps firmly to the transversely-extending lower horizontal wall 103 with a grasping frictional force sufficient to allow the device 10 to remain attached to the horizontal wall 103 when the ratcheting lock 70 is installed onto the protruding locking end portion 14, without the need for the user to manually hold the locking end 14 of the device. In such embodiments, the grasping frictional force of the locking device upon the horizontal wall should be at least about 5 newtons (N), and up to and including about 10 N.

The length L (FIG. 5B) of the pair of laterally-extending upper wall 20 and lower wall 22 of the attaching portion 12, which extend transversely along the transversely-extending lower horizontal wall 103 of the file cabinet is typically from about 3 cm to about 12 cm, preferably at least about 4 cm, and including at least about 5 cm, and up to about 10 cm, and including up to about 8 cm. The narrow slot opening formed between the lower horizontal portion 103 of the upper front of the file cabinet and the upper horizontal edge 109 of the cabinet drawer constrains the attaching end of the elongated member and prevents the elongated member from wiggling. In addition to the minimum gap X distance and the resilience of the material, the length of the frictional contact (between horizontal wall 103 of the frame and the attaching end of the locking device) affects the grasping frictional force, and these three features can be configured to provide a grasping frictional force that is sufficient but not excessing. In another embodiment of the invention, it is preferred to minimize the distance forward by which the distal end 43 of the locking device extends from the front face of the file cabinet after the locking means has been attached.

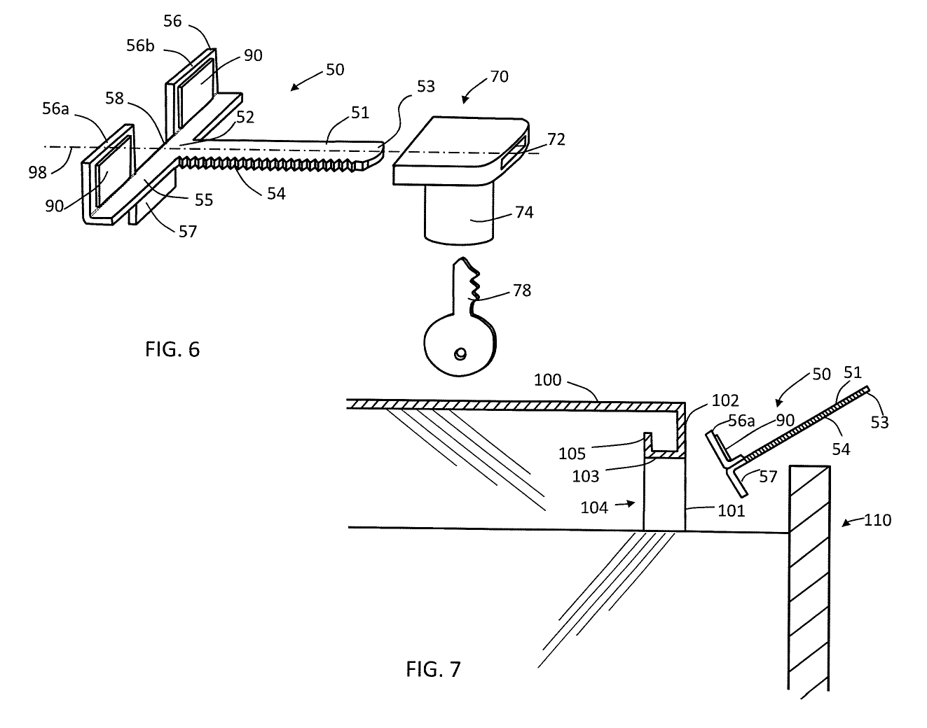

FIG. 6 shows a second embodiment of a locking device 50 including a main elongated body, illustrated as a planar bar 51, having an attaching end 52 and a locking end 53. The attaching end 52 also includes a laterally-extending base 55 that extends from both side edges of the attaching end 52, and at least one upturned wall 56, illustrated as a pair of upturned walls 56a and 56b extending from the rearward edge 58 of the transverse base 55 on both sides of the planar bar 51, and extending in a lateral direction (transverse) to the long axis 98, and perpendicular to the plane of the planar bar 51.

The locking end 53 has a rounded edge for easier insertion into the slot 72 of a lock 70. The bar 51 includes a plurality of lock engaging elements 54 (teeth or ridges) disposed along a portion of one side edge. The transverse slot 72 of the ratcheting lock 70 has a shape and size suitable to receive slidably the locking end 53 and the elongated planar bar 51 of the locking device, and a cylinder lock portion 74 having a keyway (not shown) to receive the blade of an operable key 78.

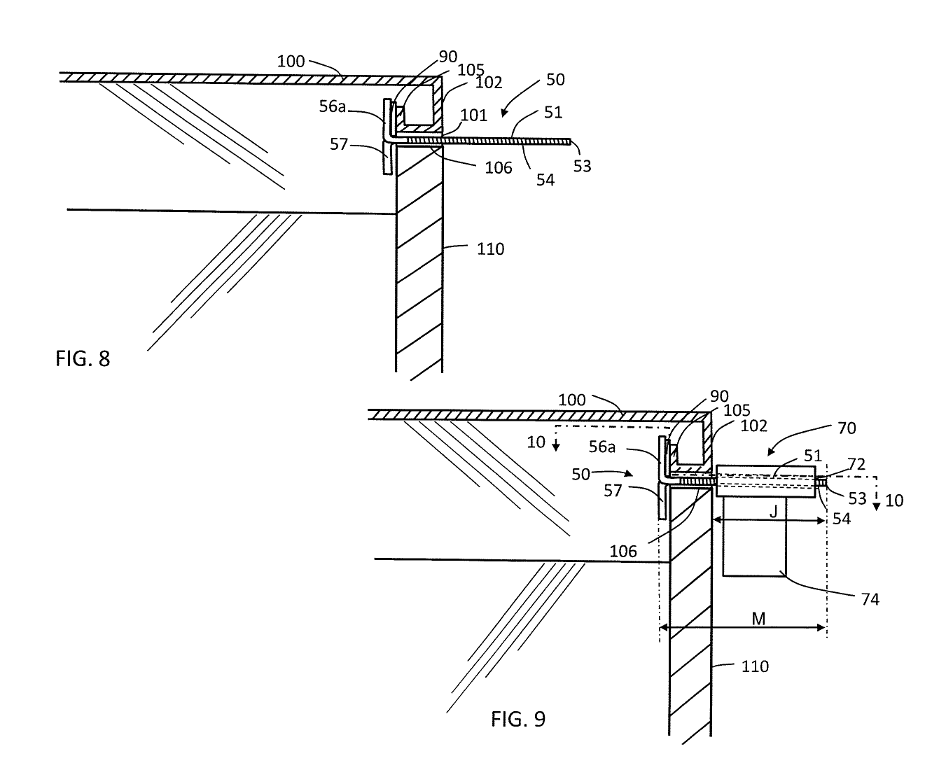

In one aspect of the invention, the locking device 50 is useful in locking the drawer of the second style of file cabinet shown in FIGS. 7 through 10. This file cabinet includes a top surface 100, a front cabinet surface 102 having a file drawer frame 101, and a file drawer 110 disposed and movable horizontally and rearwardly within the file drawer frame 101. The upper portion of file drawer frame 101 includes a horizontal wall 103 defining a portion of the drawer opening 104, and an interior vertical wall 105 extending perpendicularly from an inner edge of the horizontal wall 103. FIG. 7 shows the file drawer 110 in the open position, allowing a user to install the locking device 50. After insertion into the opened file drawer 110, the upturned walls 56a and 56b are placed flush against the interior vertical wall 105, and the file drawer 110 is closed into the file drawer frame 101, as shown in FIG. 8, with the locking end 53 of the elongated planar bar 51 extending through the upper slot opening 106 formed between the file drawer 110 when the drawer 110 is fully closed within the file drawer frame 101.

To temporarily fix the locking device 50 to the interior vertical wall 105, and prevent it from falling due to gravity, a fastener 90 is secured to the forward-facing surface of the upturned walls 56a and 56b, and a releasable fastening portion thereof is attached temporarily and releasably to the rearward-facing surface of interior vertical wall 105, to temporarily hold the locking device 50 in place, without manual support or holding, while the file drawer 110 is being closed. The fastener 90 can include an adhesive material having a pressure-sensitive adhesive, a hook and loop mechanical fastener such as VELCRO® fastener (the other of the hook and loop mechanical fastener is affixed to the lateral vertical wall of the drawer frame), or a magnetic material, which magnetically attaches to the steel wall of the file cabinet. A suitable magnetic material is a neodymium magnet.

Optionally the attaching end 52 can include at least one downturned wall 57 (shown in FIG. 6) extending perpendicularly from the plane of the planar bar 51. The upturned walls 56a and 56b and the downturned wall 57 provide a stop wall at the attaching end 52, which extends both above and below the planar bar 51. The upwardly extending wall(s) engages the interior vertical wall 105 of the file cabinet to anchor the locking device from being pulled through the slot opening between the drawer and the frame once the locking means has been applied to the device. The interior vertical wall 105 of a conventional file cabinet can be about 0.5-1 cm in height, such as 0.8 cm. Likewise, the downwardly extending wall 57 prevents manipulating the locking device 50 through the upper slot opening 106 once the locking means has been applied to the locking end of the locking device 50.

One can appreciate that various configurations of an upwardly extending wall(s) can be employed that engage the interior vertical wall 105 to anchor the locking device from being pulled through the drawer opening once the locking means has been applied to the device. Likewise, various configurations of a downwardly extending wall can be employed that to prevent manipulating the locking device 50 through the drawer opening once the locking means has been applied to the device.

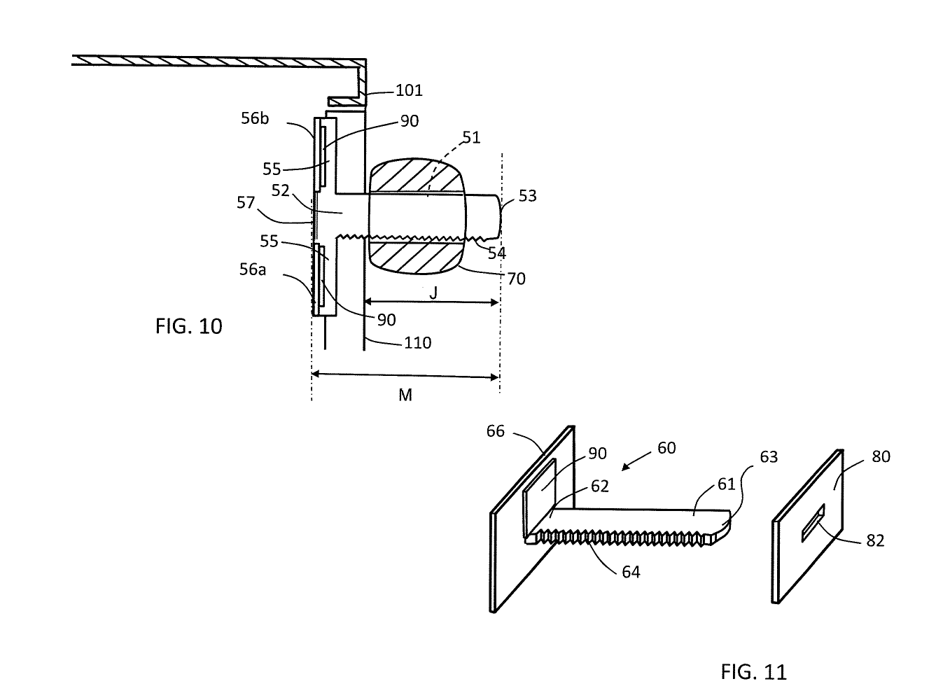

After the locking device 50 is inserted into the drawer opening 104 and temporarily attached to the file drawer frame 101 using the fastener 90, the file drawer 110 is closed, as shown in FIG. 8. A locking means, illustrated as a ratcheting lock 70, is installed over the rounded locking end 53 of the elongated planar bar 51 to engage ratchetingly the teeth 54 along the side edge of the bar 51, thereby securing closed the drawer 110, as shown in FIGS. 9 and 10. The ratcheting lock 70 (its pawl teeth) can be disengaged from the row of teeth 54 along the side of the locking end 53 by inserting and rotating the key 78 (shown in FIG. 6) within the keyway of the cylinder lock portion 74, thereby allowing the ratcheting lock 70 to be slid off and removed from the locking end 53.

The width of the transverse base 55 of the locking device 50 is typically about 5 cm to about 12 cm, preferably from about 8 cm to about 10 cm. The upturned walls 56 and the downturned wall 57 are typically about 1 cm to about 2 cm in height.

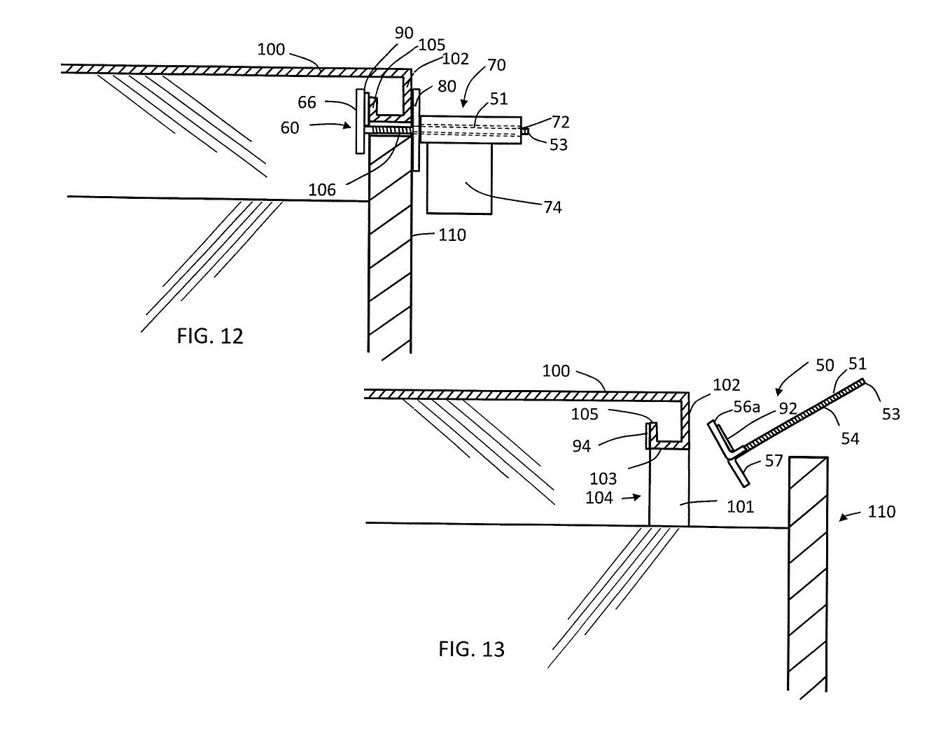

FIGS. 11 and 12 show a third embodiment of a locking device 60 including an elongated planar bar 61 having an attaching end 62 and a locking end 63. A perpendicular wall 66 is fixed to the attaching end 62 proximate the transverse center and slightly below the vertical center of the wall 66. A fastener 90, as described herein before, can be fixed or attached to the inner surface of the wall 66, just above the bar 61.

Also illustrated in FIGS. 11 and 12 is a planar barrier plate or guard 80 having a transverse slot 82 sized to accommodate the size and shape of the bar 61 of the locking device. The guard 80 can be made of a plastic or any of the materials used for constructing the locking device. The planar surfaces of the guard can also be coated with a plastic material to reduce chipping or scratching of the surfaces of the file cabinet. The guard 80 protects against the lock 70 from marring the outer surface of the file drawer 110 and file drawer frame 101, as illustrated in FIG. 12. It is understood that a guard can be used with the first or second embodiments of the locking device shown in FIG. 1 or FIG. 6, and with any other embodiments herein.

FIG. 13 illustrates an alternative embodiment of the locking device of FIG. 6 wherein the fastener 90 is a hook and loop mechanical fastener 92. The fastener 92 is either the loop fastener member or the hook fastener member, which is typically attached adhesively to the forward-facing surface of the upturned walls 56a and 56b. The mating mechanical fastener 94 attached to the rearward-facing surface of the interior vertical wall 105 is the other of the loop fastener member or the hook fastener member, and is likewise typically attached adhesively.

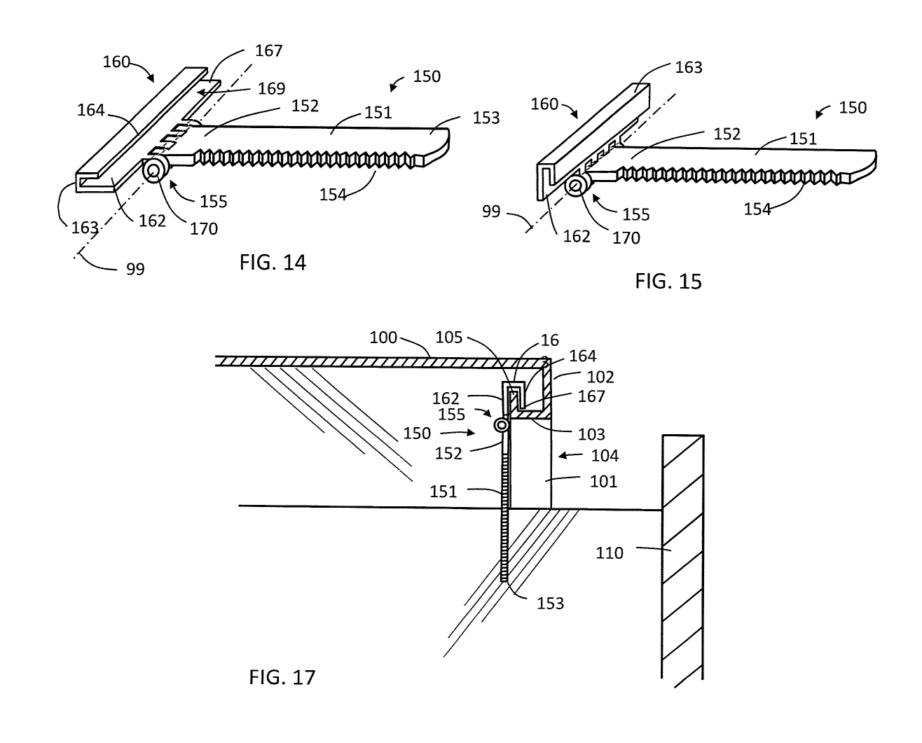

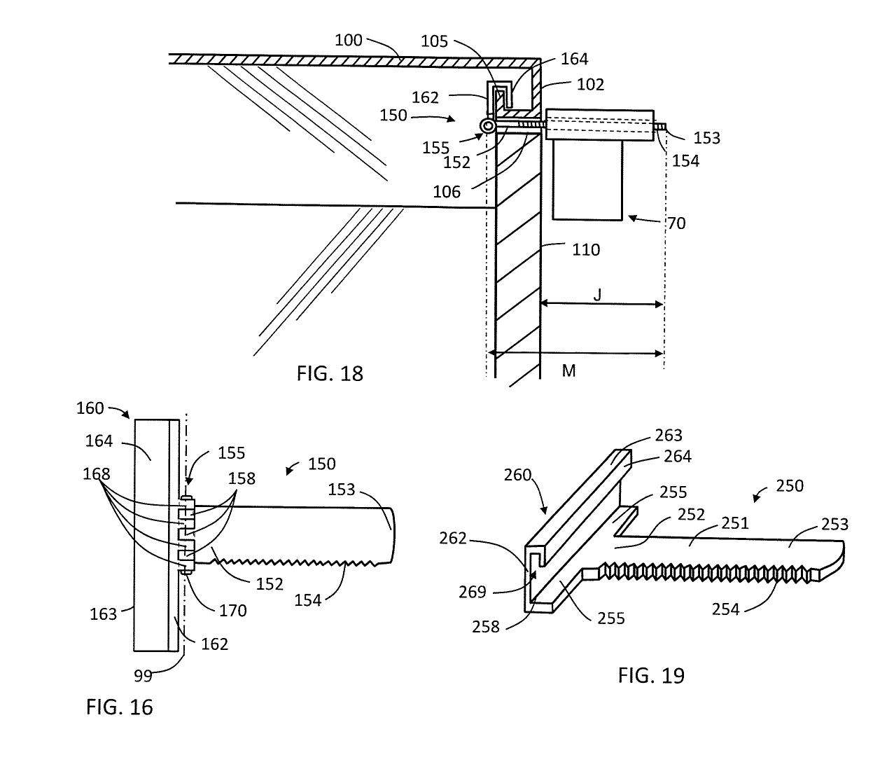

FIGS. 14-18 illustrate a fourth embodiment of the locking device 150 that employs a grasping member to grasp the top edge of the interior vertical wall 105 to prevent its withdrawal. The locking device 150 includes an elongated bar 151 that includes a locking end 153 and an opposing attaching end 152. A hinge 155 is secured to the attaching end 152 and to a grasping member 160, for pivoting movement of the grasping member 160 between an extended position shown in FIG. 14, and a grasped or installed position shown in FIG. 15. The hinge 155 can be any hinging member that allows the grasping member 160 to be moved or manipulated between the two positions. In the illustrated embodiment, shown in FIG. 16, the hinge 155 includes a plurality of circular loops 158 fixed to the distal edge of the attaching end 152 along an axis line 99, and a plurality of corresponding circular loops 168 extending from the proximal edge of the extending member 162 of the hooking member 160, and spaced between the loops 158. The loops 158 and 168 are interlaced pivotally along the axis 99 with an elongated pin 170.

FIGS. 14 and 15 show the extending member 162 extending from the hinge 155, and a shorter return member 164 extending from the distal end 163 of the extending member 162 back toward the hinge 155, and spaced apart from the extending member 162 by a gap 169 having a dimension. The gap dimension is typically about 1 mm to about 2 mm. The gap accommodates insertion of the grasping member over a thickness of the upper edge of the interior vertical wall 105 of the file cabinet. Once hooked over the interior vertical wall 105, as shown in FIG. 17, any downward force or torque upon the locking device 150 ensures that the grasping member 160 does not disengage during use. The user grasps the locking end 153 of the planar bar 151 and holds it along the lower horizontal wall 103 while closing the file drawer 110, and locks the device with the locking means 70. The return member 164 can extend any distance back toward the hinge 155 that is sufficient to easily clasp the interior vertical wall 105, while remaining engaged with the top edge thereof. The confronting surfaces of the extending member 162 and the return member 164 do not need to grip the interior vertical wall 105, although the gap 169 should not be so large that the device could tilt over and off of the interior vertical wall 105.

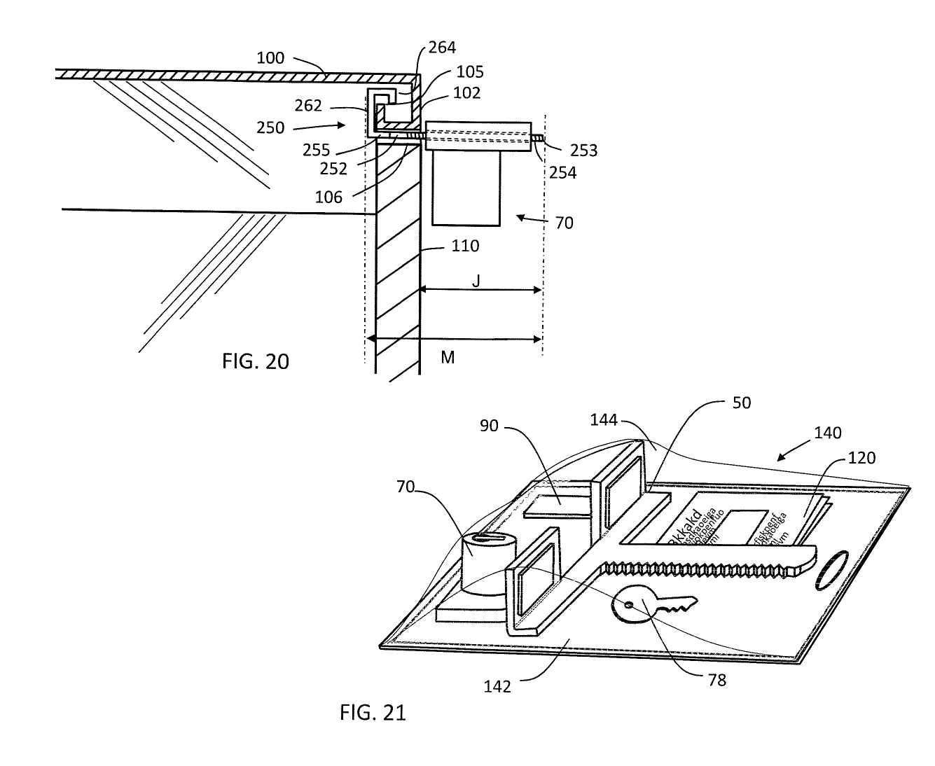

FIGS. 19 and 20 illustrate a fifth embodiment of a locking device 250 that employs a grasping member to grasp the top edge of the interior vertical wall 105 to assist in installation of the locking device, and to help prevent its withdrawal. The locking device 250 includes an elongated bar 251 that includes a locking end 253 and an opposing attaching end 252. A grasping member 260 includes an extending member 262 that extends from the attaching end 252, and a shorter return member 264 that extends from the distal end 263 of the extending member 262, back toward the attaching end 252, and is spaced apart from the extending member by a gap 269 having a dimension, similar to that of the fourth embodiment. The attaching end 252 includes a transverse base 255 that extends laterally from both side edges of the attaching end 252. The extending member 262 extends from the rearward edge 258 of the transverse base 255 on both sides of the elongated bar 251.

Once hooked over the interior vertical wall 105, any downward force or torque upon the locking device 250 ensures that the grasping member 260 does not disengage from the vertical wall 105 during the initial placement of the locking device 250 to the file drawer frame. The user manipulates the locking end 253 of the planar bar 251 and holds it along the lower horizontal wall 103 while closing the file drawer 110, and locks the device 250 with the locking means 70. The return member 264 can extend any distance back toward the attaching end 252 that is sufficient to easily clasp the interior vertical wall 105, while remaining engaged with the top edge thereof and while providing a clearance to allow the forward-facing surface of the extending member 262 to fully contact the rearward-facing surface of the interior vertical wall 105. The confronting surfaces of the extending member 262 and the member 264 do not need to grip the interior vertical wall 105, although the gap 269 should not be so large that the device could tilt over and off of the interior vertical wall 105. In all embodiments of the locking system herein, the distal edge of the locking end (for example, distal edge 43 in FIGS. 5A and 5B, distal edge 53 in FIGS. 9 and 10, and distal edge 153 in FIG. 18) can be configured to extend forwardly from the front surface of the vertical outer wall 102 of the file cabinet, a distance J of at least 1.2 inches (about 3 cm) and less than about 2 inches (about 5 cm), and preferably less than about 1.6 inches (4 cm). It has been determined that the conventional ratcheting lock 70 has a depth dimension R (FIG. 5A) along the locking portion 14 is about 1.1 inches (2.7 cm). The length of the locking device 10 that is configured to extend through and beyond the slot opening 106 between the drawer and the frame is sufficient to pass at least a little further through the conventional ratcheting lock 70, so that at least end-most tooth 44z, or the tooth next to it, engages the ratcheting mechanism of the lock, to secure and lock the drawer. This prevents the distal edge of extending beyond the ratcheting lock 70 from sticking out forwardly from the file cabinet, farther than is needed to attach the locking means, where it can snag a person or their clothing walking past the file cabinet. It has been determined that the ratcheting lock 70 can be attached to very near the distal edge 43 of the locking end 14, even catching the very last tooth 44z, and can remain securely locked.

For some conventional file cabinets having a horizontal wall 103 with an edge, as shown in FIG. 3, the depth of the rearward-most edge of the horizontal wall 103 is about 0.9-2.0 cm (about 0.35-0.8 inch). Consequently, the total length K of a locking device 10 is the distance from the distal end of the attaching end to the distal end of the locking portion, as illustrated in FIG. 5A, and is at least about 1.5 inches (3.8 cm) and up to about 2.4 inches (6.0 cm).

For other conventional file cabinets having an interior vertical wall 105, as shown in FIG. 9 or 18, the depth of the rearward-most surface of the interior vertical wall 105 is about 2.5 cm (about 1 inch). Consequently, the total length M of a locking device 50 or 60 (FIGS. 9 and 12) or locking device 150 (FIG. 18) or locking device 250 (FIG. 20), is the distance from the distal end of the attaching end to the distal end of the locking portion. The total length M is at least about 2.1 inches (5.2 cm), and up to about 2.5 inches (6.4 cm).

As shown in FIG. 5A, a rubber, soft plastic or silicone cap 96 can be placed over the distal end 43 of the locking end after attaching and securing the ratcheting locking 70, for further safety.

Non-limiting examples of a material for the locking device, providing resilience and durability, include aluminum, hardened steel, tempered steel, chrome-plated steel, stainless steel, other metals and alloys, thermoplastic materials, including polycarbonate, acrylic, etc., and laminates and components thereof.

The invention also relates to instructions associated with the use of a locking device with a file cabinet, directing the consumer as to the manner and means to insert and attach the locking device to the file cabinet, and to close and lock closed the drawer in the file cabinet. The invention also relates to a method of closing and locking a drawer of a file cabinet using the locking device. Typically the method for securing closed a drawer within a drawer opening of a file cabinet comprises the steps of: a) opening a drawer of a file cabinet; b) attaching the attaching end portion of the locking device to the file drawer frame of the file cabinet; c) closing the drawer to expose the locking end portion; and d) attaching a locking means to the locking end to prevent the drawer from opening within the drawer opening.

As illustrated in FIG. 21, the invention also relates to an article of manufacture 140 comprising any one of the embodiments of a locking device (though the locking device 50 is illustrated), the locking means 70 and one or more keys 78, and optional fasteners 90, packaged in association with instructions 120 with a board 142 and clear overwrap 144, for use by a consumer of the locking device with a file cabinet, and with a method of locking and securing a drawer of the file cabinet using the locking device.

We claim:

1. A locking system for a drawer of a standard file cabinet, and in particular a steel-constructed file cabinet, including a locking device including a main elongated body that includes a locking end and an opposing attaching end, a distal end of the attaching end including a laterally-extending member to engage a drawer-opening frame of the file cabinet, and the locking end configured to extend forwardly through a slot opening between the drawer-opening frame and a top edge of the drawer, and a locking means securable to the locking end.

2. The locking system of claim 1 wherein the distal end of the attaching end includes an upturned portion and the laterally-extending member extends from the upturned portion.

3. The locking system according to claim 2 wherein the upturned portion includes an upturned wall and the laterally-extending member is a hooking member extending forwardly from an upper end of the upturned wall toward the locking end, substantially parallel to the main elongated body and spaced apart from the main elongated body by an attaching gap having a dimension, wherein the attaching gap accommodates insertion of a thickness of an inwardly- and transversely extending horizontal wall of an upper edge of the drawer-opening frame which defines a portion of the file drawer opening.

4. The locking system of claim 3, wherein the upturned wall is a laterally-extending upturned wall, and further includes a lower laterally-extending member extending from a lower end of the upturned wall, wherein a distal end of the lower laterally-extending member and a distal end of the laterally-extending hooking member have a substantially constant lateral attaching gap therebetween that accommodates insertion of the thickness of the horizontal wall of the drawer-opening frame.

5. The locking system of claim 3, wherein the gap between the lower laterally-extending member and the laterally-extending hooking member tapers toward the respective distal ends to form a pinching gap therebetween that accommodates frictional insertion of the thickness of the horizontal wall of the drawer-opening frame.

6. The locking system of claim 3, wherein the distal end of the upper laterally-extending hooking member further includes an upturned distal edge for easier insertion of the horizontal wall of the drawer-opening frame into the pinching gap.

7. The locking system of claim 3, wherein the upturned portion includes at least one upturned wall extending perpendicularly from and laterally outward from both sides of the elongated bar.

8. The locking system of claim 7, further including a downturned wall extending perpendicularly from the attaching end.

9. The locking system of claim 1, wherein the attaching end includes a transverse base portion extending laterally with or parallel to the plane of the elongated bar, wherein the upturned wall extends from the transverse base portion.

10. The locking system of claim 9, wherein the transverse base portion extends from both side edges of the attaching end.

11. The locking system of claim 9, wherein the upturned wall of the locking device has a forward-facing surface that faces the locking end, and further including a fastener attached to the forward-facing surface of the upturned wall.

12. The locking system of claim 1, wherein the laterally-extending member is a planar wall oriented substantially perpendicular to the main elongated body, and the attaching end of the main elongated body attaches proximate the center of the planar wall, and further including a fastener attached to the forward-facing surface of the planar wall.

13. The locking system of claim 12, wherein the fastener is selected from the group consisting of a pressure-sensitive adhesive layer, a hook and loop mechanical fastener, and a magnetic fastener.

14. The locking system of claim 1, wherein the attaching end further includes a hinge, and the laterally-extending member is a laterally-extending clasping member extending from the hinge, the clasping member including an extending member having a distal end, and a return member extending from the distal end toward the hinge, and spaced apart from the extending member by a gap, wherein the gap accommodates insertion of the return member over an upper edge of an interior vertical wall along an upper edge of a file drawer frame of a file cabinet.

15. The locking system of claim 1, wherein the locking end includes a plurality of teeth along a side edge of the elongated bar, and the locking means comprises a ratcheting lock to engage ratchetingly the teeth to secure the ratcheting lock to the locking end.

16. The locking system of claim 1, wherein the distal end of the locking end is configured to extend less than about 2.4 inches from the distal end of the attaching end.

17. A method for using a locking system according to claim 1 for securing closed a file drawer within a file drawer opening of a file cabinet, comprising the steps of: opening a drawer of a file cabinet; attaching the attaching end portion of the locking device to an interior portion of a file drawer frame of the file cabinet; extending the locking end through the drawer opening while closing the drawer, to expose the locking end through a slot opening between the top of the file drawer and the file drawer frame; and attaching the locking means of the locking system to the locking end portion to prevent the closed file drawer from opening within the drawer opening.

18. The method of claim 17 wherein the interior portion is a transversely-extending horizontal wall of the file drawer frame, the attaching end comprises a hooking member, and the step of attaching comprises hooking the hooking member over the transversely-extending horizontal wall.

19. The method of claim 18 wherein the interior portion is an interior vertical wall of the file drawer frame, the attaching end includes a transverse base portion extending laterally with or parallel to the plane of the elongated bar, wherein the upturned wall extends from the transverse base portion, and a fastener attached to a forward-facing surface of the upturned wall, and the step of attaching comprising attaching the forward facing surface to the interior vertical wall using the fastener, where the fastener is selected from the group consisting of a pressure-sensitive adhesive layer, a hook and loop mechanical fastener, and a magnetic fastener.

20. An article of manufacture comprising: a locking device and optionally a lock and one or more keys; instructions for use by a consumer of the locking device with a file cabinet, for locking and securing a drawer of the file cabinet using the locking device; and a package for securing together the locking device, the optional lock and one or more keys, and the instructions.
